(19) United States
(12) Patent Application Publication
(10) Pub. No.: US 2013/0132659 A1
(43) Pub. Date: May 23, 2013

(54) MICROCONTROLLER AND METHOD OF CONTROLLING MICROCONTROLLER

(71) Applicant: PANASONIC CORPORATION, Osaka (JP)

(72) Inventors: Hiroyuki ODAHARA, Osaka (JP); Jiro MIYAKE, Osaka (JP)

(73) Assignee: PANASONIC CORPORATION, Osaka (JP)

(21) Appl. No.: 13/738,448

(22) Filed: Jan. 10, 2013

Related U.S. Application Data
(63) Continuation of application No. PCT/JP2011/000843, filed on Feb. 16, 2011.

(30) Foreign Application Priority Data
Jul. 13, 2010 (JP) 2010-159201

(51) Int. Cl. G06F 12/02

(52) U.S. Cl. CPC G06F 12/0246
USPC 711/104

(57) ABSTRACT

A microcontroller includes a RAM control unit configured to: perform a RAM access operation when an address designated by a CPU is within a range of a designated area; and read a program from a Flash EEPROM when the address is out of the range of the designated area. As the RAM access operation, the RAM control unit is configured to: read the program from the Flash EEPROM, store the read program into the RAM, and change valid bit information into a valid state, when the valid bit information indicates an invalid state; and output the program stored in the RAM to the CPU when the valid bit information indicates the valid state.

### CROSS REFERENCE TO RELATED APPLICATION

This is a continuation application of PCT International Application No. PCT/JP2011/000843 filed on Feb. 16, 2011, specifying the United States of America, which is based on and claims priority of Japanese Patent Application No. 2010-159201 filed on Jul. 13, 2010. The entire disclosures of the above-identified applications, including the specifications, drawings and claims are incorporated herein by reference in their entirety.

### FIELD

The present invention relates to microcontrollers and methods of controlling the microcontrollers, and particularly relates to a microcontroller including a nonvolatile memory.

### BACKGROUND

A conventional one-chip microcontroller uses, as a program memory, a nonvolatile memory typified by an electrically erasable programmable ROM (EEPROM) in which programs for controlling an operation of the microcontroller are stored. Using such a nonvolatile memory as a program memory provides an advantageous effect that a program stored in the EEPROM can be changed easily through an electrical operation. Specifically, the user only needs to rewrite the program in a storage area where changes are required, without having to change the mask. Thus, it is possible to expedite development of one-chip microcontrollers having different programs while saving costs, without depending on IC manufacturers.

Although using EEPROM as the nonvolatile memory provides the above-described advantageous effect, there is a problem that the EEPROM consumes a large amount of power when a program code is read from the EEPROM for causing the one-chip microcontroller to operate.

A technique disclosed in Patent Literature (PTL) 1 is known as a conventional technique to solve the above problem. In the technique disclosed in PTL 1, a RAM which has a smaller capacity than that of a nonvolatile memory is used. In the technique, when a program which has a small capacity and is used for a specific operation is executed, a program required for the operation is stored in the RAM which is low-power-consumption and a nonvolatile memory which is high-power-consumption is disabled. Then, the technique disclosed in PTL 1 executes the program using the RAM which has the small capacity. In this manner, the technique disclosed in PTL 1 makes it possible to reduce power consumption.

### CITATION LIST

### Patent Literature

[PTL 1] Japanese Unexamined Patent Application Publication No. 2000-105701

### SUMMARY

### Technical Problem

However, with the technique disclosed in PTL 1, it is required to first transfer to the RAM the program to be executed when executing the program using the RAM. Therefore, hardware or software for transferring the program is additionally required. Furthermore, when executing the program using the RAM, it is required to transit an execution PC of the microcontroller to a location address of the RAM by executing a branch instruction for example, since the RAM is preliminarily decided and located in an address. This makes program development more complicated. Therefore, the advantageous effect to reduce power consumption is significantly undermined by executing the program using the RAM.

The present invention has been conceived to provide a microcontroller by which power consumption can be saved and complication of program development can be suppressed.

### Solution to Problem

In order to achieve the above object, a microcontroller according to an aspect of the present invention includes: a nonvolatile memory in which programs for controlling an operation of the microcontroller are stored; a RAM; a CPU which designates an address in the nonvolatile memory and executes a program which is stored at the address in the nonvolatile memory; an area holding unit configured to hold information indicating a designated area that is part of the memory area in the nonvolatile memory; a valid holding unit configured to hold valid bit information indicating one of a valid state in which a program stored in the RAM is valid and an invalid state in which the program is invalid; and a RAM control unit configured to: perform a RAM access operation when the address designated by the CPU is within a range of the designated area; and perform a nonvolatile memory access operation when the address designated by the CPU is out of the range of the designated area, the nonvolatile memory access operation including reading from the nonvolatile memory a program at the address designated by the CPU and outputting the read program to the CPU, wherein, as the RAM access operation, the RAM control unit is configured to: read from the nonvolatile memory a program at the address designated by the CPU, store the read program into the RAM, and change the valid bit information into the valid state, when the valid bit information indicates the invalid state; and output the program stored in the RAM to the CPU when the valid bit information indicates the valid state.

With this configuration, when a read request is sent from the CPU for a program stored in the nonvolatile memory, the microcontroller according to an aspect of the present invention stores the program into the RAM. Furthermore, the microcontroller according to an aspect of the present invention outputs the program stored in the RAM to the CPU upon subsequent reading of the program from the CPU. Thus, the microcontroller according to an aspect of the present invention can reduce a frequency of reading operation to the nonvolatile memory, thereby saving power consumption. Moreover, the microcontroller according to an aspect of the present invention can automatically transfer the program stored in the nonvolatile memory to the RAM in response to the read request from the CPU. Thus, the CPU can perform processing without having to paying attention to the existence of the RAM. Accordingly, the microcontroller according to an aspect of the present invention can suppress complication of program development.

Furthermore, the microcontroller may further include a mode holding unit configured to hold information indicating an operation mode of the microcontroller, wherein the RAM control unit may be configured to: perform the RAM access operation when the mode holding unit holds information indicating a first operation mode that is predetermined and when the address designated by the CPU is within the range of the designated area; and perform the nonvolatile memory access operation when the mode holding unit holds information indicating a second operation mode that is different from the first operation mode.

With this configuration, the microcontroller according to an aspect of the present invention can save power consumption in a specific first operation mode. Furthermore, the microcontroller according to an aspect of the present invention can simplify the control in the second operation mode by not using the RAM in the second operation mode. Thus, the microcontroller according to an aspect of the present invention can perform the operation in the second operation mode fast.

Furthermore, the first operation mode may be a low-speed mode in which a clock rate is lower than a clock rate of the second operation mode.

With this configuration, the microcontroller according to an aspect of the present invention can further save power consumption in an operation mode in which a clock rate is low and low power consumption is demanded.

Furthermore, the nonvolatile memory may store, as the programs, a first program used in the first operation mode and a second program used in the second operation mode, a capacity of the RAM may be larger than a capacity of the first program, and the designated area may be an area in which the first program is stored.

With this configuration, in the microcontroller according to an aspect of the present invention, it is not required to rewrite the program stored in the RAM again once the first program is transferred to the RAM. Thus, the microcontroller according to an aspect of the present invention can further reduce the frequency of the reading operation to the nonvolatile memory, thereby further saving power consumption.

Furthermore, the mode holding unit may hold a flag accessible from the CPU as information indicating the operation mode of the microcontroller.

With this configuration, the microcontroller according to an aspect of the present invention can simplify the configuration of the mode holding unit.

Furthermore, the area holding unit may be configured to hold information indicating a starting address of the designated area as the information indicating the designated area, and the RAM control unit may be configured to determine, as the designated area, an area starting from the starting address and having a size equivalent to a capacity of the RAM.

With this configuration, the microcontroller according to an aspect of the present invention can reduce a capacity (number of registers) of the area holding unit, thereby saving costs for the microcontroller.

Furthermore, the RAM control unit may include a mode switching unit configured to stop the nonvolatile memory when the RAM access operation is performed.

With this configuration, the microcontroller according to an aspect of the present invention can reduce standby power consumption of the nonvolatile memory, thereby further saving power consumption.

It is to be noted that the present invention can be implemented not only as the microcontroller described above but also (i) as a method of controlling the microcontroller including the characteristic units included in the microcontroller as steps and (ii) as a program which causes a computer to execute such characteristic steps. It goes without saying that such a program can be distributed via a recording medium such as a CD-ROM or the like or a transmission medium such as the Internet.

Moreover, the present invention can be implemented as a semiconductor integrated circuit (LSI) in which a part or all of the function of the microcontroller is implemented.

### Advantageous Effects

With the above, the present invention can provide a microcontroller by which power consumption can be reduced and complication of program development can be suppressed.

### BRIEF DESCRIPTION OF DRAWINGS

These and other objects, advantages and features of the invention will become apparent from the following description thereof taken in conjunction with the accompanying drawings that illustrate a specific embodiment of the present invention.

FIG. 1 is a block diagram of a microcontroller according to Embodiment 1 of the present invention.

FIG. 2A shows a data example stored in a Flash EEPROM according to Embodiment 1 of the present invention.

FIG. 2B shows the data example stored in the Flash EEPROM according to Embodiment 1 of the present invention.

FIG. 3 shows a configuration example of a RAM according to Embodiment 1 of the present invention.

FIG. 4 shows an example of valid information according to Embodiment 1 of the present invention.

FIG. 5 is a flowchart of processing performed by the microcontroller according to Embodiment 1 of the present invention.

FIG. 6 shows an example of an operation performed by the microcontroller according to Embodiment 1 of the present invention.

FIG. 7 is a block diagram of a microcontroller according to Embodiment 2 of the present invention.

FIG. 8 shows an example of a designated area according to Embodiment 2 of the present invention.

FIG. 9 is a flowchart of processing performed by the microcontroller according to Embodiment 2 of the present invention.

FIG. 10 is a block diagram of a microcontroller according to Embodiment 3 of the present invention.

FIG. 11 is a flowchart of processing performed by the microcontroller according to Embodiment 3 of the present invention.

### DESCRIPTION OF EMBODIMENTS

Embodiments according to the present invention are described below with reference to drawings. It is to be noted that constituents assigned with the same numerals in the embodiments perform similar operations, and therefore description is not repeated in some cases.

### Embodiment 1

When a read request is sent from a CPU 103 for a program stored in a Flash EEPROM 101, a microcontroller 100 according to Embodiment 1 of the present invention stores the program into a RAM 102. Furthermore, the microcontroller 100 outputs the program stored in the RAM 102 to the CPU 103 upon subsequent reading of the program from the CPU 103. Thus, the microcontroller 100 can reduce the frequency of a reading operation to the Flash EEPROM 101, thereby saving power consumption. Moreover, the microcontroller 100 can automatically transfer the program stored in the Flash EEPROM 101 to the RAM 102 in response to the read request from the CPU 103. Thus, the CPU 103 can perform the processing without having to paying attention to the existence of the RAM 102. Accordingly, the microcontroller 100 according to an aspect of the present invention can suppress complication of program development.

First, description is provided on the configuration of the microcontroller 100 according to Embodiment 1 of the present invention.

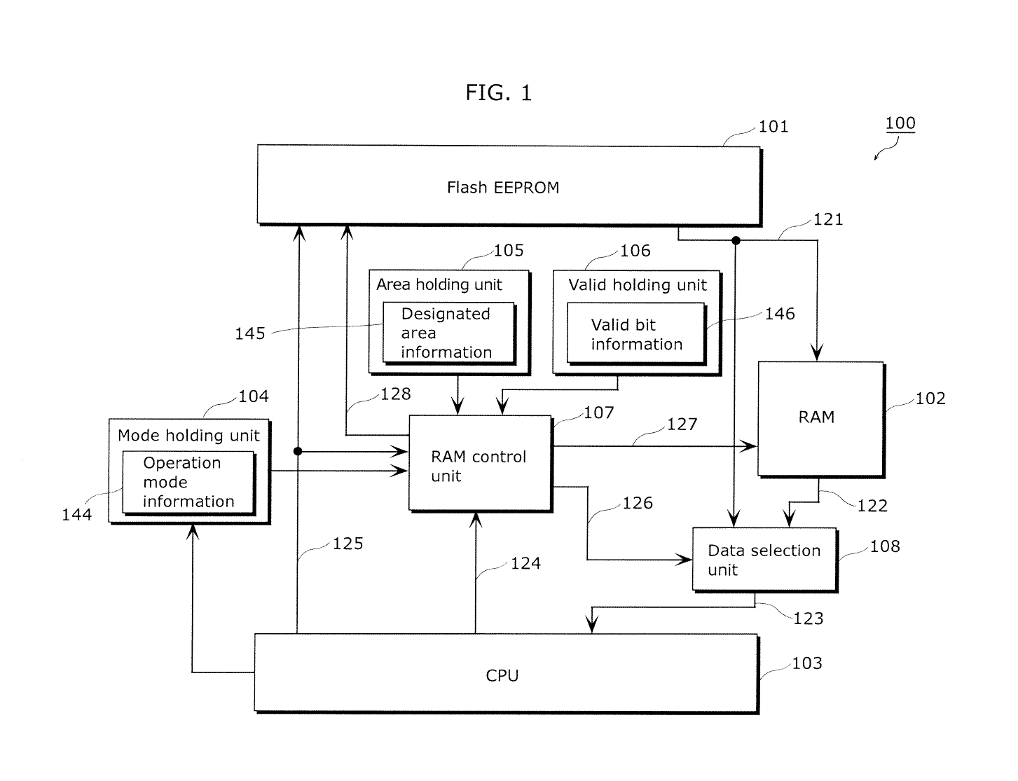

FIG. 1 is a block diagram of the microcontroller 100 according to Embodiment 1 of the present invention.

The microcontroller 100 shown in FIG. 1 includes: a Flash EEPROM 101 that is a nonvolatile memory; a RAM 102; a CPU 103; a mode holding unit 104; an area holding unit 105; a valid holding unit 106; a RAM control unit 107; and a data selection unit 108.

In the Flash EEPROM 101, programs for controlling the operation of the microcontroller 100 are stored.

The RAM 102 is for use in temporarily storing a program stored in the Flash EEPROM 101.

The CPU 103 designates an address in the Flash EEPROM 101, and executes a program which is stored at the address in the Flash EEPROM 101. The CPU 103 has: a normal mode in a high clock rate; and a low-speed mode (low-power-consumption mode) in which a clock rate is lower than a clock rate of the high clock rate. Furthermore, when reading a program stored in the Flash EEPROM 101, the CPU 103 outputs: an address signal 125 for designating an address in the Flash EEPROM 101; and an access request signal 124 for requesting reading of the data at the address.

The mode holding unit 104 holds operation mode information 144 indicating an operation mode (normal mode or low-speed mode) of the CPU 103. Furthermore, the mode holding unit 104 is a register which holds, as the operation mode information 144, a flag which is readable/writable from the CPU 103, for example. Thus, the configuration of the mode holding unit 104 can be simplified.

The area holding unit 105 holds designated area information 145 indicating a designated area 155 that is part of the memory area of the Flash EEPROM 101. For example, the area holding unit 105 is configured with a register of one or more bit and is accessible from the CPU 103. Furthermore, the designated area information 145 is, for example, information for designating a starting address and a final address of the designated area 155.

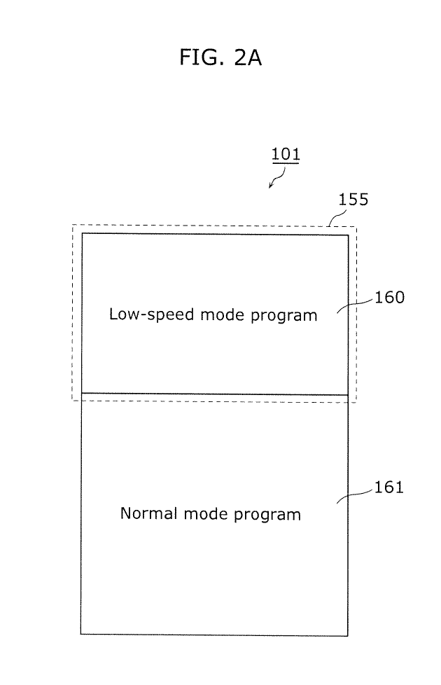

FIG. 2A and FIG. 2B each shows an example of the program stored in the Flash EEPROM 101 and the designated area 155.

As shown in FIG. 2A and FIG. 2B, the followings are stored in the Flash EEPROM 101: a low-speed mode program 160 executed in the low-speed mode; and a normal mode program 161 executed in the normal mode. It is to be noted that other programs or data other than programs may be stored in the Flash EEPROM 101.

Furthermore, the designated area 155 includes only an address area in which the low-speed mode program 160 is stored. For example, as shown in FIG. 2A, the designated area 155 includes the entire address area in which the low-speed mode program 160 is stored. Furthermore, as shown in FIG. 2B, the designated area 155 may include only part of the address area in which the low-speed mode program 160 is stored.

The valid holding unit 106 holds valid bit information 146 indicating one of a valid state in which a program stored in the RAM 102 is valid and an invalid state in which the program is invalid. For example, the valid holding unit 106 is configured with a register of one or more bit and is accessible from the CPU 103.

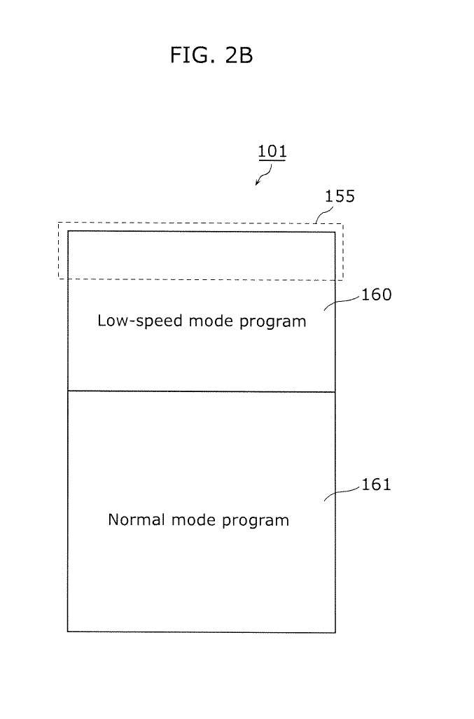

FIG. 3 shows a configuration example of the RAM 102. For example, the capacity of the RAM 102 is 1K byte. Furthermore, the RAM 102 includes 32 lines 165 each being 32 bytes.

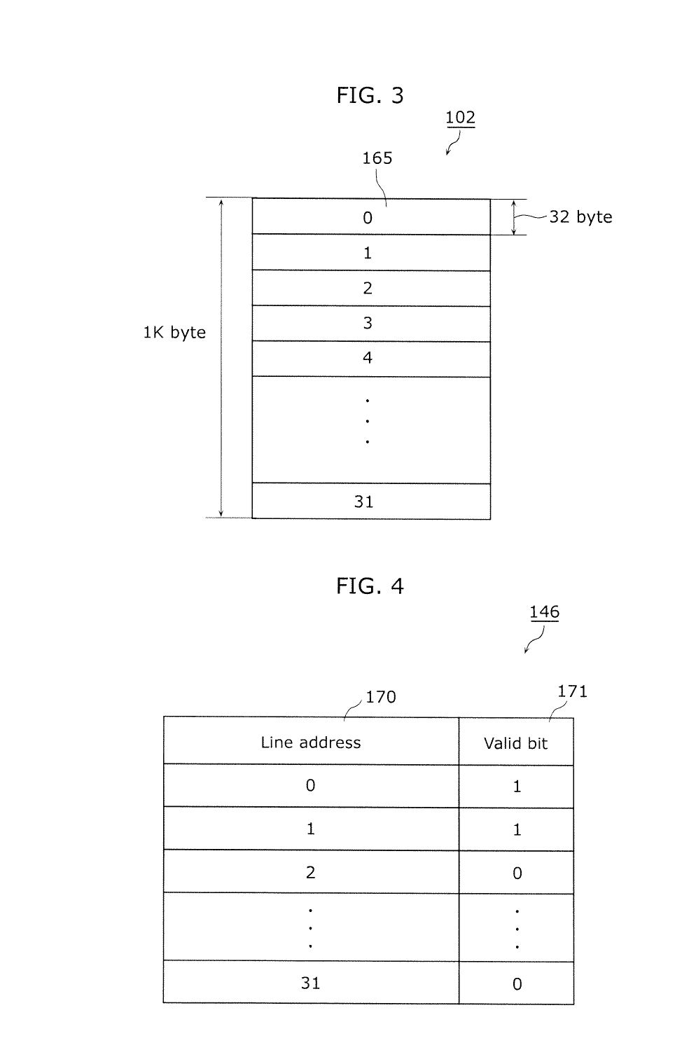

FIG. 4 shows an example of the valid bit information 146.

The valid bit information 146 includes a plurality of line addresses 170 and a plurality of valid bits 171 each associated with each of the line addresses 170. For example, the valid bit information 146 includes 32 line addresses 170 and 32 valid bits 171.

Furthermore, each of the line addresses 170 corresponds to any one of the lines 165 included in the RAM 102. Furthermore, each of the line addresses 170 is associated with an address, which is included in the designated area 155, of 32-byte unit in the Flash EEPROM 101. Furthermore, the valid bit 171 indicates whether the data stored in the line 165 at the line address 170 corresponding to the valid bit 171 is valid that is “1” or invalid that is “0”.

Although the valid holding unit 106 holds a plurality of valid bits 171, the valid holding unit 106 may hold at least greater than or equal to one valid bit 171.

The RAM control unit 107 controls access to the RAM 102 according to: the operation mode information 144 held in the mode holding unit 104; the valid bit information 146 held in the valid holding unit 106; the designated area information 145 held in the area holding unit 105; and the access request signal 124 generated by the CPU 103. Furthermore, the RAM control unit 107 generates: a selection control signal 126 for controlling the data selection unit 108; an access control signal 127 for controlling the RAM 102; and an access request signal 128 for requesting reading to the Flash EEPROM 101.

The data selection unit 108 selects one of data outputted from the Flash EEPROM 101 to a data bus 121 and data outputted from the RAM 102 to a data bus 122, according to the selection control signal 126 from the RAM control unit 107. Then, the data selection unit 108 outputs the selected data to the CPU 103 via a data bus 123.

Furthermore, the RAM control unit 107 performs the RAM access operation when (i) the low-speed mode is designated by the operation mode information 144 and (ii) a request address 166 that is an address designated by an address signal 125 is within a range of the designated area 155.

Furthermore, the RAM access operation is an operation in which the RAM control unit (1) reads from the Flash EEPROM 101 a program stored at the request address 166, stores the read program into the RAM 102, and changes the valid bit 171 into the valid state, when the valid bit 171 indicates the invalid state and (2) outputs the program stored in the RAM 102 to the CPU 103 when the valid bit 171 indicates the valid state.

Furthermore, the RAM control unit 107 performs the nonvolatile memory access operation (i) when the normal mode is designated by the operation mode information 144 and (ii) when the low-speed mode is designated by the operation mode information 144 and the request address 166 is out of the range of the designated area 155.

Furthermore, the nonvolatile memory access operation is an operation in which a program stored at the request address 166 is read from the Flash EEPROM 101 and the read program is outputted to the CPU 103.

Here, it takes time to determine whether or not the request address 166 is within the range of the designated area 155. Therefore, by not using the RAM 102 in the normal mode, it is possible to simplify the control in the normal mode. Thus, the operation in the normal mode can be performed fast.

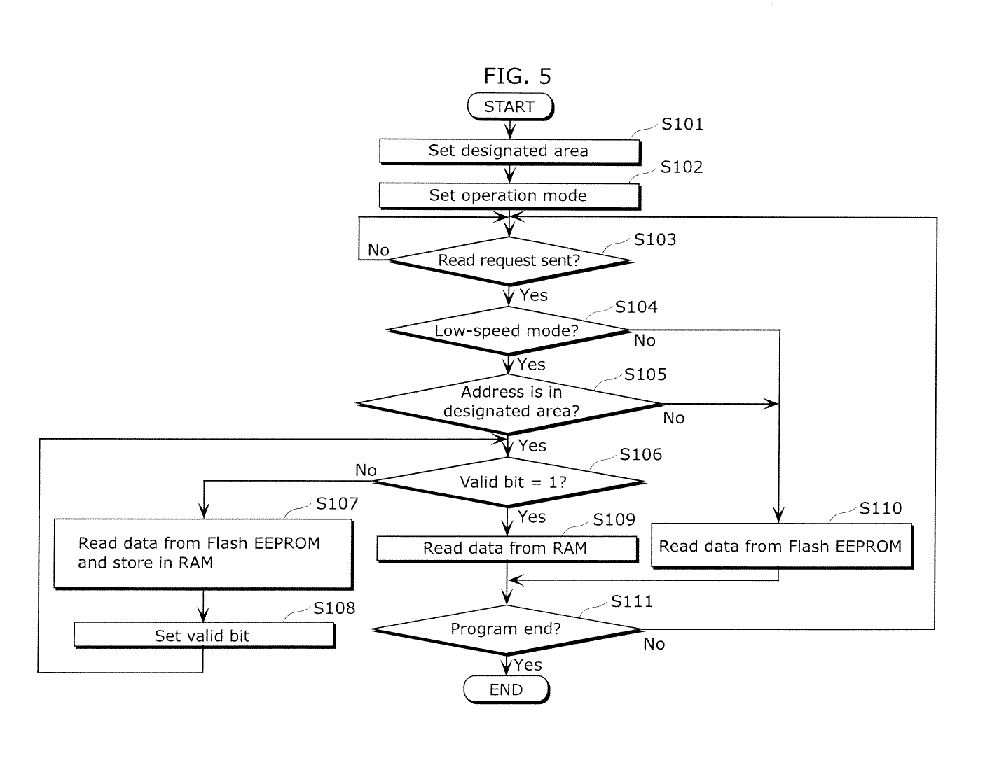

The following describes the operation performed by the microcontroller 100 having such a configuration, with reference to the flowchart shown in FIG. 5.

First, the CPU 103 sets the designated area 155 to the area holding unit 105 (S101).

Furthermore, the CPU 103 sets the operation mode to the mode holding unit 104 (S102).

Then, the RAM control unit 107 confirms the access request signal 124 outputted from the CPU 103 (S103).

When the access request signal 124 is outputted (Yes in S103), the RAM control unit 107 confirms the operation mode indicated by the operation mode information 144 (S104).

When the operation mode information 144 indicates the low-speed mode (Yes in S104), the RAM control unit 107 then determines whether or not the request address 166 indicated by the address signal 125 outputted from the CPU 103 is within the range of the designated area 155 indicated by the designated area information 145 (S105).

When the request address 166 is within the range of the designated area 155 (Yes in S105), the RAM control unit 107 then confirms the valid bit 171 of the line address 170 corresponding to the request address 166 from among the valid bits included in the valid bit information 146. Thus, the RAM control unit 107 determines whether or not request data that is data stored in the request address 166 in the Flash EEPROM 101 is stored in the RAM 102 (S106).

It is to be noted that the valid bit 171 is set to the invalid state “0” in the initial state, and the data in the RAM 102 is in the invalid state.

When the valid bit 171 corresponding to the request address 166 is in the invalid state “0” (No in S106), the RAM control unit 107 reads the request data from the Flash EEPROM 101 and writes the read request data into the line 165 in the RAM 102 which is divided into 32 lines (S107).

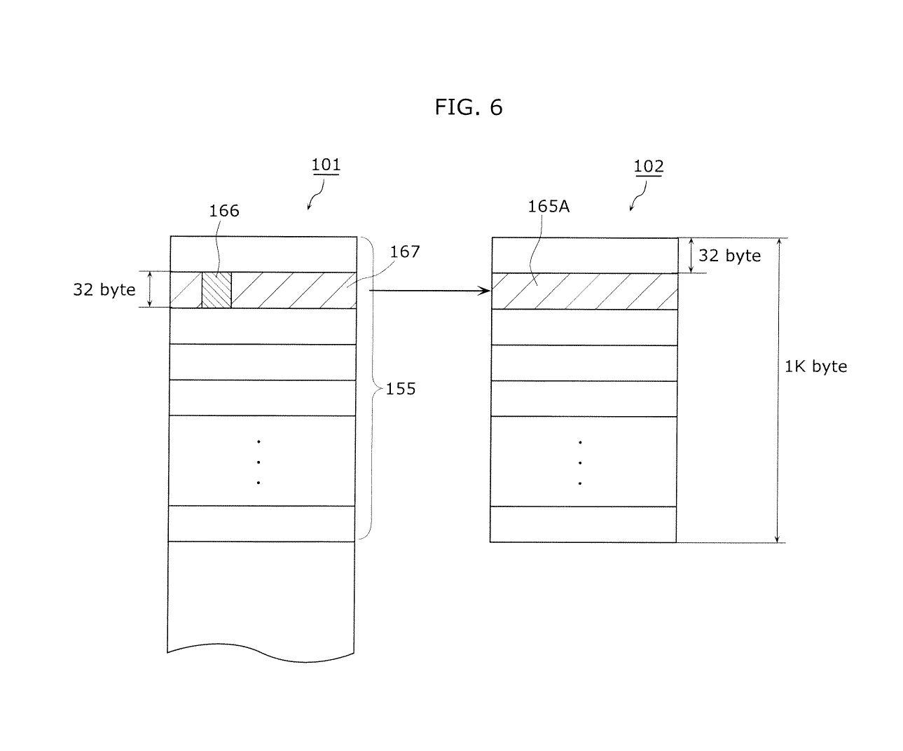

FIG. 6 shows a specific example of the operation in S107. For example, assume that the request address 166 shown in FIG. 6 is designated by the address signal 125.

In this case, the RAM control unit 107 transmits to the Flash EEPROM 101 the access request signal 128 designating a transfer address range 167 including the request address 166. Here, the transfer address range 167 is an address range in which, for example, 32-byte data corresponding to one of the line addresses 170 and the valid bit 171 is stored. Specifically, assuming that the request address 166 is 32n+x (n is any one of 0 to 31, x is any one of 0 to 31), the transfer address range 167 is the address range of 32n+0 to 32n+31.

Thus, the Flash EEPROM 101 outputs to the data bus 121 transfer data which is data of 32 bytes and is stored in the transfer address range 167.

Here, one transfer address range 167 corresponds to any one of the line addresses 170 included in the valid bit information 146. Furthermore, one line address 170 corresponds to one valid bit 171 and one line 165 included in the RAM 102. Specifically, one line address 170, one valid bit 171, one line 165 and one address in the RAM 102 correspond to the request address 166.

Next, the RAM control unit 107 transmits to the RAM 102 the access control signal 127 for instructing to write the transfer data into a line 165A corresponding to the request address 166 from among the lines 165 included in the RAM 102. Thus, the RAM 102 stores into the line 165A the transfer data which is 32 byte of the data bus 121.

It is to be noted that the RAM control unit 107 may (i) perform reading from the Flash EEPROM 101 and writing into the RAM 102 for each of 1-byte data included in the 32-byte transfer data or (ii) read the 32-byte transfer data from the Flash EEPROM 101 and then write the 32-byte transfer data into the RAM 102.

Furthermore, for example, it is predetermined to which one of the lines 165 in the RAM 102 the data in each of the transfer address ranges 167 in the Flash EEPROM 101 is stored. In other words, it is predetermined to which one of the addresses in the RAM 102 the data at each of the addresses included in the designated area 155 in the Flash EEPROM 101 is stored. Accordingly, the RAM control unit 107 can automatically determine the address (line 165) into which the data is written for the designated transfer address range 167 (request address 166).

Specifically, for example, assuming that the starting address of the designated area 155 is y, the data in the address range of address y+32 m+0 to y+32 m+31 (m is any one of 0 to 31) in the Flash EEPROM 101 is written into the address range of address 32m+0 to 32 m+31 in the RAM 102. For example, when m=0, the data in the address range of address y+0 to y+31 is written into the address range of address 0 to 31 in the RAM 102.

Next, the RAM control unit 107 sets the valid bit 171 corresponding to the request address 166 to the valid state “1” (S108).

During the time, the CPU 103 is in a memory access wait state. Furthermore, the RAM control unit 107 updates the valid bit 171, and then confirms the valid bit 171 again in 5106. Since the valid bit 171 corresponding to the request address 166 is in the valid state “1” (Yes in S106) in this case, the RAM control unit 107 then reads the request data from the RAM 102 and outputs the read request data to the CPU 103 (S109). Specifically, the RAM control unit 107 transmits to the RAM 102 the access control signal 127 for instructing to read data at the address corresponding to the request address 166. Thus, the RAM 102 outputs to the data bus 122 the request data at the address corresponding to the request address 166. Furthermore, the RAM control unit 107 transmits to the data selection unit 108 the selection control signal 126 for instructing to select the data bus 122. Thus, the data selection unit 108 outputs to the CPU 103 the request data of the data bus 122, via the data bus 123.

Meanwhile, when the operation mode information 144 indicates a mode other than the low-speed mode (No in S104) or when the request address 166 is out of the range of the designated area 155 (No in S105), the RAM control unit 107 reads the request data directly from the Flash EEPROM 101 and outputs the read request data to the CPU 103 (S110). Specifically, the RAM control unit 107 transmits the access request signal 128 to the Flash EEPROM 101. Then, the Flash EEPROM 101 outputs to the data bus 121 the request data stored at the request address 166. Furthermore, the RAM control unit 107 transmits to the data selection unit 108 the selection control signal 126 for instructing to select the data bus 121. Thus, the data selection unit 108 outputs to the CPU 103 the request data which is of the data bus 121 and is outputted from the Flash EEPROM 101, via the data bus 123.

Furthermore, when the program is not ended after S109 or S110 is performed (No in S111), the processing subsequent to 5103 is performed again. Furthermore, processing of 5103 to S110 is repeated until the program is ended (Yes in S111).

With the above operation, when (i) in the low-speed mode and (ii) the program executed by the CPU 103 is stored in the RAM 102, the program is read from the RAM 102. Thus, the microcontroller 100 can reduce the number of times of the reading operation to the Flash EEPROM 110, thereby saving power consumed by the reading operation to the Flash EEPROM 110. Therefore, the microcontroller 100 can achieve low power-consumption as a whole.

Furthermore, the software (program) side does not have to pay attention to the existence of the RAM 102. Therefore, the same software as in the case where the RAM 102 is not used can be used for the microcontroller 100, which suppresses complication of program development.

In this manner, the microcontroller 100 according to Embodiment 1 of the present invention can reduce power consumption and suppress complication of program development.

Although S107 and S108 are executed and then the processing transits to S106 again when the valid bit 171 is “0” (No in S106) in the above description, the processing may transit to S111 after the request data read from the Flash EEPROM 101 is outputted to the CPU 103 in S107.

Furthermore, the processing order shown in FIG. 4 is an example and the order of each of the steps may be interchanged within a range that the similar result can be obtained, and part of the processing may be performed simultaneously. For example, the order of S104, S105, and S106 may not be the order shown in FIG. 4, and part of the processing may be performed simultaneously.

Furthermore, although the capacity of the RAM 102 is described as 1K byte in the above description, the capacity of the RAM 102 is not limited to the above. It is to be noted that it is preferable that the capacity of the RAM 102 is larger than the capacity of the low-speed mode program 160 stored in the Flash EEPROM 101. With this, it is not required to rewrite the program stored in the RAM 102 again once the low-speed mode program 160 is transferred to the RAM 102. Thus, the microcontroller 100 can further reduce the frequency of the reading operation to the Flash EEPROM 101, thereby further saving power consumption.

Furthermore, although an example in which the Flash EEPROM is used is shown in the above description, another nonvolatile memory may be used as long as it is a rewritable nonvolatile memory such as a FeRAM.

Furthermore, although the RAM 102 is used in the low-speed mode in the above description, the RAM 102 may be used in another specific operation mode. For example, the RAM 102 may be used in the normal mode. Even in this case, the same advantageous effect can be provided. However, it is more preferable to use the RAM 102 in the above-described low-speed mode, since power consumption can be saved further which is required for the low-speed mode.

Although the area holding unit 105 is configured with a register in the above description, the area holding unit 105 may hold the designated area information 145 indicating the designated area 155 which is fixed and is predetermined. Thus, the register can be deleted and costs for the microcontroller 100 can be saved.

Furthermore, the area holding unit 105 may hold the designated area information 145 indicating a plurality of designated areas 155.

### Embodiment 2

In Embodiment 2 of the present invention, a modification of the microcontroller 100 according to above-described Embodiment 1 is described.

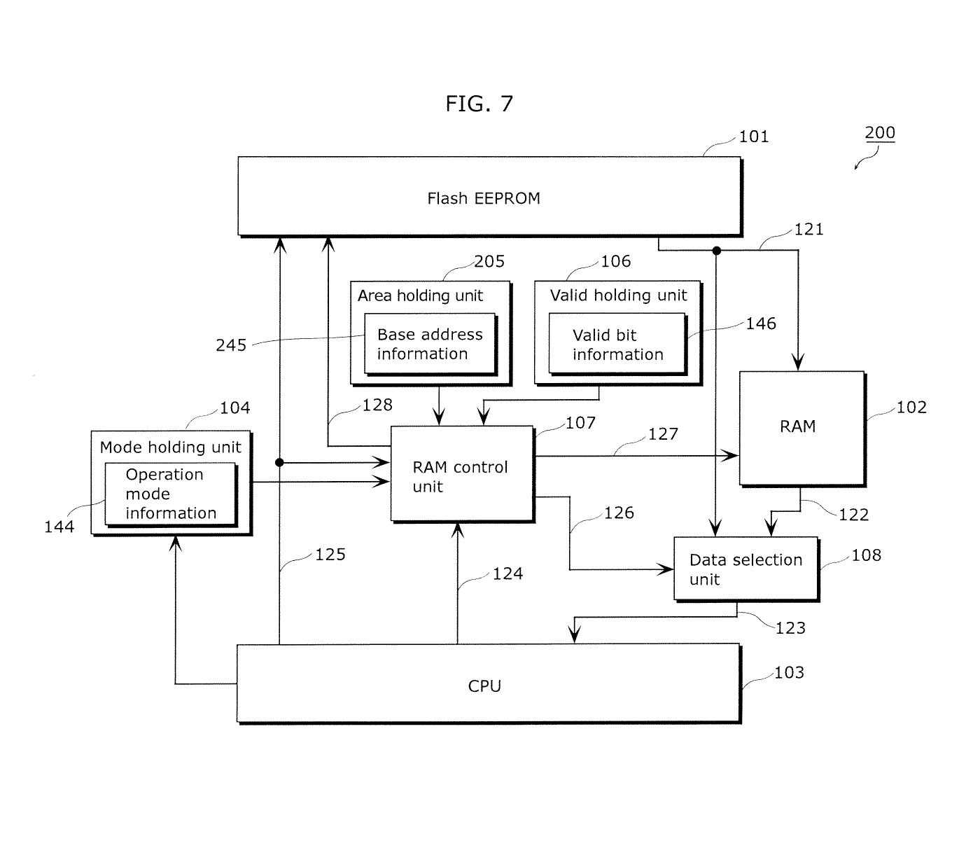

FIG. 7 is a block diagram of a microcontroller 200 according to Embodiment 2 of the present invention. It is to be noted that similar constituents as those in FIG. 1 are assigned with the same numerals. Furthermore, the following description focuses on difference from Embodiment 1 and description is omitted when overlapped.

The microcontroller 200 shown in FIG. 7 includes an area holding unit 205 which has a different configuration from the area holding unit 105 in the configuration of the microcontroller 100 shown in FIG. 1.

Here, it is assumed that the Flash EEPROM 101 is assigned at 0x40000000 to 0x400FFFFF in the memory space. Furthermore, the CPU 103 designates an address in the Flash EEPROM 101 by an address signal 125 which is 32 bits.

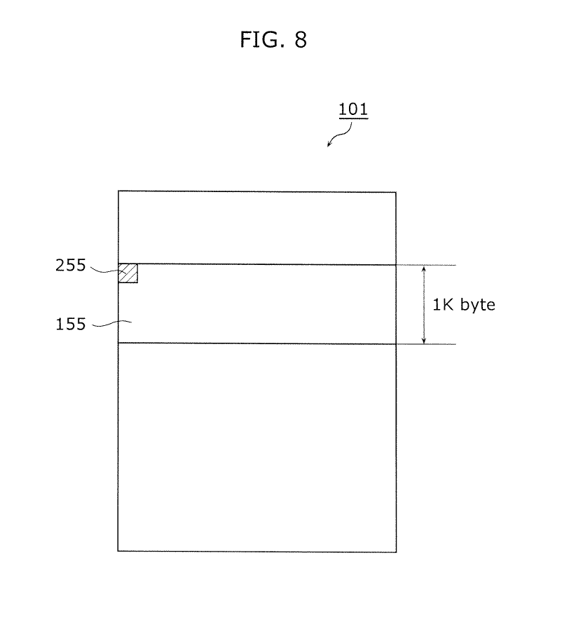

The area holding unit 205 holds base address information 245 indicating a base address 255 in the Flash EEPROM 101. This base address 255 is a starting address of the designated area 155, as shown in FIG. 8. Furthermore, this base address 255 is an address which designates 22 higher-order bits out of the address which is 32 bits in the Flash EEPROM 101. For example, the area holding unit 205 is configured with a register accessible from the CPU 103.

Furthermore, the RAM control unit 107 determines, as the designated area 155 including data to be stored in the RAM 102, a space of 1K byte which is a size equivalent to a capacity of the RAM 102, based on the base address 255 indicated by the base address information 245.

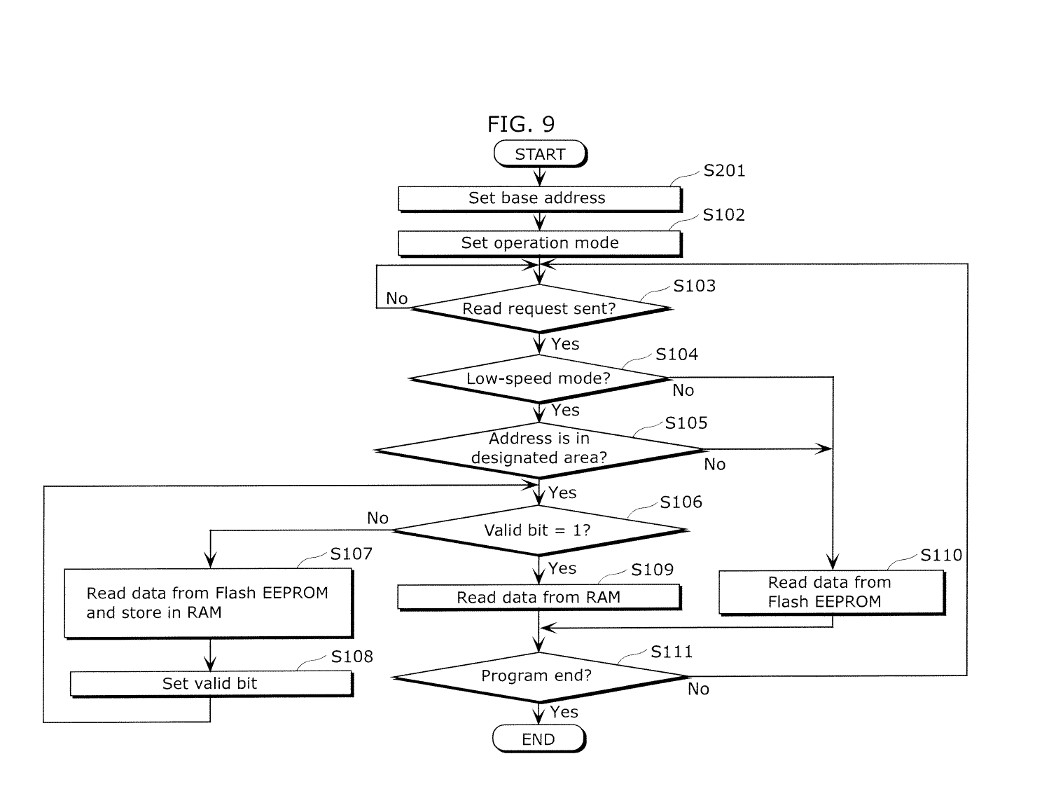

The following describes the operation performed by the microcontroller 200 having such a configuration, with reference to the flowchart shown in FIG. 9.

First, the CPU 103 sets base address information 245 to the area holding unit 205 (S201). Here, the area of the low-speed mode program 160 is preliminarily set to be within 1K byte that is the capacity of the RAM 102, and the low-speed mode program 160 is arranged so that the low-speed mode program 160 starts from an address having 0x0000 as the 10 lower-order bits.

It is to be noted that the processing subsequent to 5102 is similar to that of Embodiment 1, and therefore the description is omitted.

With the above, the microcontroller 200 according to Embodiment 2 of the present invention can reduce the number of the registers of the area holding unit 205 by preliminarily limiting the arrangement area of the program to be stored in the RAM 102, in addition to providing the advantageous effect of the microcontroller 100 according to Embodiment 1 described above. Thus, costs for the microcontroller 200 can be saved.

Although the area holding unit 205 is configured with the register in the above description, the area holding unit 205 may hold the base address information 245 indicating the base address 255 which is fixed and is predetermined. Thus, the register can be deleted and costs for the microcontroller 200 can be further saved.

Furthermore, the area holding unit 205 may hold base address information 245 indicating a plurality of the base addresses 255. Thus, it is possible to give more flexibility in the program area.

Furthermore, although the base address 255 is defined as an address which designates higher-order bits from among the addresses in the Flash EEPROM 101 in the above description, the base address 255 may be an address which designates the entire address in the Flash EEPROM 101. Even in this case, the number of the registers can be reduced as compared with the case in Embodiment 1 where the starting address and the last address are held.

### Embodiment 3

In Embodiment 3 of the present invention, a modification of the microcontroller 100 according to above-described Embodiment 1 is described.

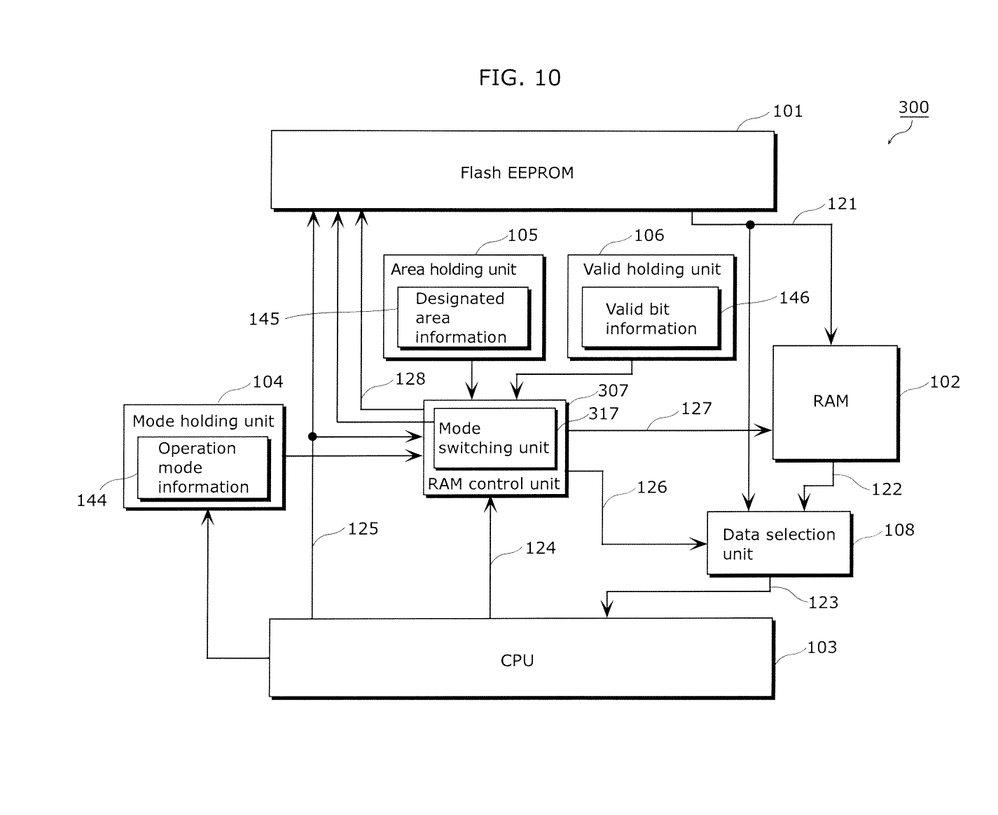

FIG. 10 is a block diagram of a microcontroller 300 according to Embodiment 3 of the present invention. It is to be noted that similar constituents as those in FIG. 1 are assigned with the same numerals. Furthermore, the following description focuses on difference from Embodiment 1 and description is omitted when overlapped.

The microcontroller 300 shown in FIG. 10 includes a RAM control unit 307 which has a different configuration from the RAM control unit 107 in the configuration of the microcontroller 100 shown in FIG. 1. Specifically, the RAM control unit 307 includes a mode switching unit 317 in addition to the function of the RAM control unit 107.

Here, the Flash EEPROM 101 has: a high-speed read mode in which an operation is performed fast; a low-speed read mode in which an operation is performed slower than in the high-speed read mode and power consumption is low; and a stop mode which is in a stop state in which power consumption is further lower than in the low-speed read mode.

The mode switching unit 317 generates a mode switching signal 320 for switching the operation mode (high-speed read mode, low-speed read mode, or stop mode) of the Flash EEPROM 101. Specifically, the mode switching unit 317 sets the operation mode of the Flash EEPROM 101 to the high-speed read mode when the operation mode of the CPU 103 is the normal mode. Furthermore, the mode switching unit 317 sets the operation mode of the Flash EEPROM 101 to the low-speed read mode when the operation mode of the CPU 103 is the low-speed mode. Moreover, the mode switching unit 317 sets the operation mode of the Flash EEPROM 101 to the stop mode when the operation mode of the CPU 103 is the low-speed mode and data is read from the RAM 102, that is, when the RAM access operation is performed.

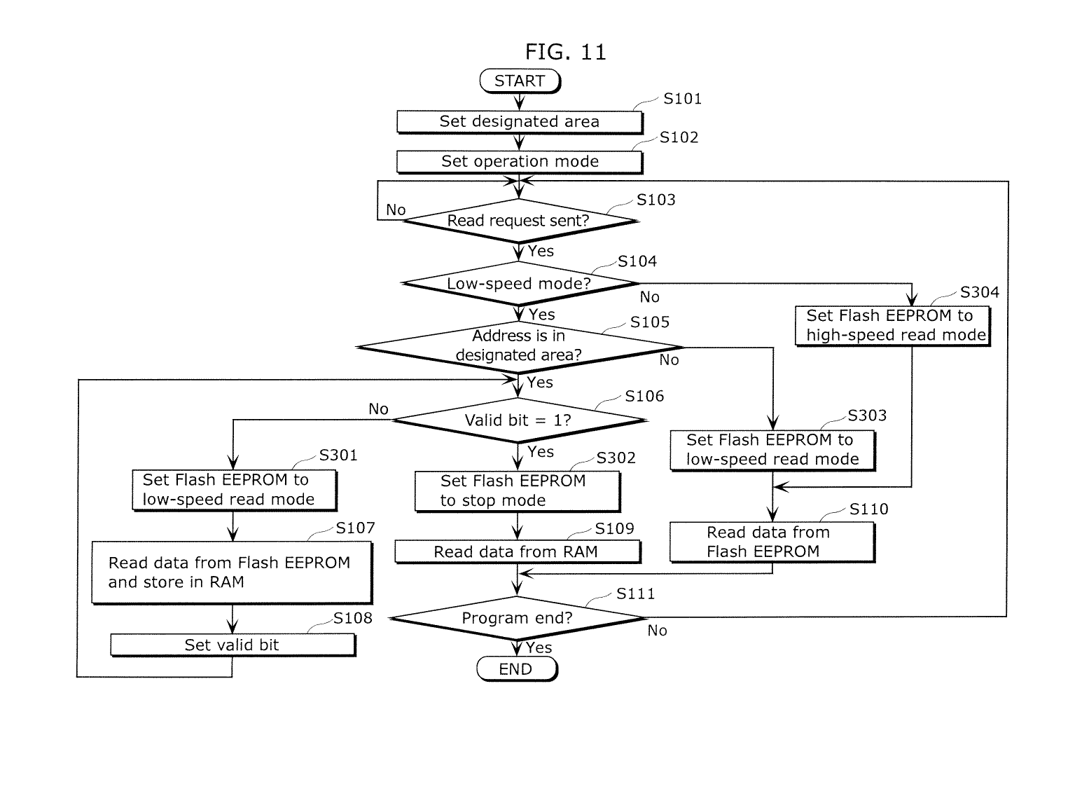

The following describes the operation performed by the microcontroller 300 having such a configuration, with reference to the flowchart shown in FIG. 11. In FIG. 11, processing of S301 to S304 is added to the processing shown in FIG. 5. Furthermore, the processing other than the above is similar to that of Embodiment 1, and therefore the description is omitted.

When the low-speed mode is indicated by the operation mode information 144 (Yes in S104), the request address 166 is within the range of the designated area 155 (Yes in S105), and the valid bit 171 corresponding to the request address 166 is in the invalid state “0” (No in S106), the mode switching unit 317 sets the operation mode of the Flash EEPROM 101 into the low-speed read mode (S301). After that, the RAM control unit 107 reads the request data from the Flash EEPROM 101, and writes the read request data to the RAM 102 (S107).

When the low-speed mode is indicated by the operation mode information 144 (Yes in S104), the request address 166 is in the range of the designated area 155 (Yes in S105), and the valid bit 171 corresponding to the request address 166 is in the valid state “1” (Yes in S106), the mode switching unit 317 sets the operation mode of the Flash EEPROM 101 to the stop mode (S302). After that, the RAM control unit 107 reads the request data from the RAM 102 and outputs the read request data to the CPU 130 (S109).

When the low-speed mode is indicated by the operation mode information 144 (Yes in 5104) and the request address 166 is out of the range of the designated area 155 (No in S105), the mode switching unit 317 sets the operation mode of the Flash EEPROM 101 to the low-speed read mode (S303). After that, the RAM control unit 107 reads the request data directly from the Flash EEPROM 101 and outputs the read request data to the CPU 103 (S110).

Furthermore, when the operation mode information 144 indicates a mode other than the low-speed mode (No in S104), the mode switching unit 317 sets the operation mode of the Flash EEPROM 101 to the high-speed read mode (S304). After that, the RAM control unit 107 reads the request data directly from the Flash EEPROM 101 and outputs the read request data to the CPU 103 (S110).

In this manner, when the microcontroller 300 reads the low-speed mode program 160 from the RAM 102, the microcontroller 300 sets the Flash EEPROM 101 to the stop mode to disable the Flash EEPROM 101. Thus, the microcontroller 300 can save the standby power consumption, in addition to the power consumption saving achieved by reducing the number of times of reading to the Flash EEPROM 101.

In this manner, the microcontroller 300 according to Embodiment 3 of the present invention can further save power consumption, in addition to providing the advantageous effect of the microcontroller 100 according to Embodiment 1.

Furthermore, each of the microcontroller 100 according to Embodiment 1, the microcontroller 200 according to Embodiment 2, and the microcontroller 300 according to Embodiment 3 is typically implemented by a one-chip semiconductor integrated circuit (LSI). It is to be noted that the processing units included in the microcontroller 100, the processing units included in the microcontroller 200, and the processing units included in the microcontroller 300 may be separately integrated into one chip, or part or all of them may be integrated into one chip.

Moreover, ways to achieve integration are not limited to the LSI, and the integration may be achieved by a dedicated circuit or a general purpose processor and so forth. It is also possible to use a Field Programmable Gate Array (FPGA) that can be programmed after manufacturing the LSI, or a reconfigurable processor in which connection and setting of circuit cells inside the LSI can be reconfigured.

Furthermore, part or all of function of the microcontroller 100 according to Embodiment 1, the microcontroller 200 according to Embodiment 2, and the microcontroller 300 according to Embodiment 3 may be implemented by causing a processor such as a CPU to execute a program.

Moreover, the present invention may be the above-described program or a recording medium on which the program is recorded. The above-described program may also be distributed via a transmission medium such as the Internet.

Furthermore, at least part of function of the microcontroller 100 according to Embodiment 1, the microcontroller 200 according to Embodiment 2, the microcontroller 300 according to Embodiment 3, and the modifications may be combined.

Furthermore, all of the numerals used in the above are used for exemplification purpose for describing the present invention more specifically, and therefore the present invention is not limited to the numerals exemplified. Moreover, the logic level represented by high/low (“0”/“1”) is used for exemplification purpose for describing the present invention more specifically, and it is also possible to obtain a similar result with a different combination of the exemplified logic level.

Moreover, any variations of the present embodiment to be conceived by those skilled in the art without departing from the spirit of the present invention are also within the scope of the present invention.

Although only some exemplary embodiments of the present invention have been described in detail above, those skilled in the art will readily appreciate that many modifications are possible in the exemplary embodiments without materially departing from the novel teachings and advantages of the present invention. Accordingly, all such modifications are intended to be included within the scope of the present invention.

### INDUSTRIAL APPLICABILITY

The present invention can be applied for microcontrollers and it is particularly effective for a microcontroller mounted with a nonvolatile memory such as an EEPROM.

1. A microcontroller comprising:
a nonvolatile memory in which programs for controlling an operation of the microcontroller are stored;
a RAM;
a CPU which designates an address in the nonvolatile memory and executes a program which is stored at the address in the nonvolatile memory;
an area holding unit configured to hold information indicating a designated area that is part of the memory area in the nonvolatile memory;
a valid holding unit configured to hold valid bit information indicating one of a valid state in which a program stored in the RAM is valid and an invalid state in which the program is invalid; and
a RAM control unit configured to: perform a RAM access operation when the address designated by the CPU is within a range of the designated area; and perform a nonvolatile memory access operation when the address designated by the CPU is out of the range of the designated area, the nonvolatile memory access operation including reading from the nonvolatile memory a program at the address designated by the CPU and outputting the read program to the CPU,
wherein, as the RAM access operation, the RAM control unit is configured to:
read from the nonvolatile memory a program at the address designated by the CPU, store the read program into the RAM, and change the valid bit information into the valid state, when the valid bit information indicates the invalid state; and
output the program stored in the RAM to the CPU when the valid bit information indicates the valid state.

2. The microcontroller according to claim 1, further comprising
a mode holding unit configured to hold information indicating an operation mode of the microcontroller,
wherein the RAM control unit is configured to:
perform the RAM access operation when the mode holding unit holds information indicating a first operation mode that is predetermined and when the address designated by the CPU is within the range of the designated area; and
perform the nonvolatile memory access operation when the mode holding unit holds information indicating a second operation mode that is different from the first operation mode.

3. The microcontroller according to claim 2,
wherein the first operation mode is a low-speed mode in which a clock rate is lower than a clock rate of the second operation mode.

4. The microcontroller according to claim 2,
wherein the nonvolatile memory stores, as the programs, a first program used in the first operation mode and a second program used in the second operation mode,
a capacity of the RAM is larger than a capacity of the first program, and
the designated area is an area in which the first program is stored.

5. The microcontroller according to claim 1,
wherein the area holding unit is configured to hold information indicating a starting address of the designated area as the information indicating the designated area, and
the RAM control unit is configured to determine, as the designated area, an area starting from the starting address and having a size equivalent to a capacity of the RAM.

6. The microcontroller according to claim 1,
wherein the RAM control unit includes a mode switching unit configured to stop the nonvolatile memory when the RAM access operation is performed.

7. A method of controlling a microcontroller,
the microcontroller including:
a nonvolatile memory in which programs for controlling an operation of the microcontroller are stored;
a RAM;
a CPU which designates an address in the nonvolatile memory and executes a program which is stored at the address in the nonvolatile memory;
an area holding unit configured to hold information indicating a designated area that is part of the memory area in the nonvolatile memory; and
a valid holding unit configured to hold valid bit information indicating one of a valid state in which a program stored in the RAM is valid and an invalid state in which the program is invalid, and
the method comprising:
performing a RAM access operation when the address designated by the CPU is within the range of the designated area; and
performing a nonvolatile memory access operation when the address designated by the CPU is out of the range of the designated area, the nonvolatile memory access operation including reading from the nonvolatile memory a program at the address designated by the CPU and outputting the read program to the CPU,
wherein the performing the RAM access operation includes:
reading from the nonvolatile memory a program at the address designated by the CPU, storing the read program into the RAM, and changing the valid bit information into the valid state, when the valid bit information indicates the invalid state; and
outputting the program stored in the RAM to the CPU when the valid bit information indicates the valid state.

8. A semiconductor integrated circuit including a microcontroller,
the semiconductor integrated circuit comprising:
a nonvolatile memory in which programs for controlling an operation of the microcontroller are stored;
a RAM;
a CPU which designates an address in the nonvolatile memory and executes a program which is stored at the address in the nonvolatile memory;
an area holding unit configured to hold information indicating a designated area that is part of the memory area in the nonvolatile memory;
a valid holding unit configured to hold valid bit information indicating one of a valid state in which a program stored in the RAM is valid and an invalid state in which the program is invalid; and
a RAM control unit configured to: perform a RAM access operation when the address designated by the CPU is within a range of the designated area; and perform a nonvolatile memory access operation when the address designated by the CPU is out of the range of the designated area, the nonvolatile memory access operation including reading from the nonvolatile memory a program at the address designated by the CPU and outputting the read program to the CPU,
wherein, as the RAM access operation, the RAM control unit is configured to:
read from the nonvolatile memory a program at the address designated by the CPU, store the read program into the RAM, and change the valid bit information into the valid state, when the valid bit information indicates the invalid state; and
output the program stored in the RAM to the CPU when the valid bit information indicates the valid state.
